(19) United States
(12) Patent Application Publication
(10) Pub. No.: US 2025/0093549 A1
(43) Pub. Date: Mar. 20, 2025

(54) METHOD FOR QUANTIFYING STRUCTURAL FEATURE FORECAST ERROR OF METEOROLOGICAL ELEMENT BASED ON GRAPHICAL SIMILARITY

(71) Applicant: Nanjing Joint Institute for Atmospheric Sciences, Nanjing (CN)

(72) Inventors: Xiyu MU, Nanjing (CN); Guoqing LIU, Nanjing (CN); Hao CHENG, Nanjing (CN); Qi XU, Nanjing (CN); Mingjian ZENG, Nanjing (CN); Kan DAI, Nanjing (CN); Hao YAN, Nanjing (CN); Shuqi YAN, Nanjing (CN); Huadong YANG, Nanjing (CN); Hao WU, Nanjing (CN); Yan ZENG, Nanjing (CN)

(73) Assignee: Nanjing Joint Institute for Atmospheric Sciences, Nanjing (CN)

(21) Appl. No.: 18/641,382

(22) Filed: Apr. 21, 2024

(30) Foreign Application Priority Data
Sep. 20, 2023 (CN) 2023112146145

(51) Int. Cl. G01W 1/02; G06F 17/18

(52) U.S. Cl. CPC G01W 1/02; G06F 17/18; G01W 2201/00

(57) ABSTRACT

A method for quantifying a structural feature forecast error of a meteorological element based on a graphical similarity is based on the concept of graphical similarity to propose a normalized evaluation technique for a forecast error of a scalar meteorological element such as rainfall, radar reflectivity, temperature, visibility, or wind speed. The method can objectively and truly reflect the true capability of forecasting the meteorological element such as precipitation.

### CROSS REFERENCE TO THE RELATED APPLICATIONS

This application is based upon and claims priority to Chinese Patent Application No. 202311214614.5, filed on Sep. 20, 2023, the entire contents of which are incorporated herein by reference.

### TECHNICAL FIELD

The present disclosure belongs to the technical field of intelligent weather forecasting, and in particular to a method for evaluating a structural feature forecast error based on a meteorological element distribution.

### BACKGROUND

With the development of numerical forecast technology and the improvement of computing power, numerical models have the ability to predict small-scale weather systems. Quantification of weather forecast error has always been a research hotspot. A reasonable definition of error can objectively reflect the forecast effect and can also be used in artificial intelligence (AI) models to guide them to learn in an objective and correct direction.

Currently, the main element of forecast error evaluation is precipitation. Chinese scientific research and operational personnel typically use traditional verification and classification methods based on target hit rate (THR), such as threat score (TS), to verify and evaluate precipitation forecasts. These verification methods mainly consider the comparison of precipitation intensity between points, and acquire the overall evaluation of precipitation through a yes/no judgment. For high-resolution precipitation forecasts, even if the rain belt structure and intensity of precipitation are consistent with the actual situation, due to subtle deviations in the location of the rain belt, there may still be excessive false alarm ratios and miss ratios, resulting in a low final forecast score. In the verification and evaluation of high-resolution models using traditional statistical verification methods, precipitation forecasts are subject to “double punishment” caused by subtle spatial and temporal differences. As a result, it is hard to acquire sufficient evaluation information and objectively reflect the true precipitation forecast capability.

To address this issue, researchers have developed various spatial verification methods. The current main spatial verification methods include neighborhood methods, scale decomposition methods, and object attributes-based spatial verification methods. The object attributes-based spatial verification methods mainly focus on analyzing the location, shape, intensity, and other attribute information of the object. Among them, a representative method is the method for object-based diagnostic evaluation (MODE). MODE determines the degree of matching between objects based on the similarity features of objects, and calculates the overall spatial similarity feature by using the centroid distance, area ratio, directional angle, overlap ratio, and other attributes between the objects as separate factors. MODE performs ellipse fitting on the verification region, which is affected by various factors such as smoothing radius and filtering threshold. The evaluation conclusions acquired from different smoothing radii lack consistency. In addition, MODE ultimately does not summarize the individual error factors of the objects into factors that can be intuitively understood by non-professional users. The neighborhood methods focus on adjusting the forecast and observation data to a larger scale by upscaling means and reducing the accidental information of high-resolution data through spatial smoothing or statistical probability distribution to measure the similarity feature between forecasts and observations. From a theoretical logic perspective, neighborhood methods are not suitable for evaluating high-resolution forecast results.

### SUMMARY

Objective of the Disclosure. To address the above problems and deficiencies in the prior art, an objective of the present disclosure is to provide a method for quantifying a structural feature forecast error of a meteorological element based on a graphical similarity. The present disclosure is based on the concept of graphical similarity to propose a normalized evaluation technique for a forecast error of a scalar meteorological element such as rainfall, radar reflectivity, temperature, visibility, or wind speed. The present disclosure can objectively and truly reflect the true capability of forecasting the meteorological element such as precipitation.

Technical Solution. In order to achieve the above objective, the present disclosure adopts the following technical solution. A method for quantifying a structural feature forecast error of a meteorological element based on a graphical similarity includes the following steps:

S1: defining a structural feature of a meteorological element field;

defining an overall structural feature \vec{α} of the meteorological element field as an area S of a spatial range covered by a meteorological element, a total numerical size R of the meteorological element in a target region, and a structure H of the meteorological element;

$$\vec{α} = [ S , R , H ] \qquad ( 1 )$$

where, \vec{α} denotes the overall structural feature of the meteorological element field;

S2: calculating a total amount error and a total area error of the meteorological element;

$${E}_{R} = \frac{\vert {RT}^{( f )} ( t ) - {RT}^{( o )} ( τ ) \vert}{max ( {RT}^{( f )} ( t ) , {RT}^{( o )} ( τ ) )} \qquad ( 2 )$$

$${E}_{S} = \frac{\vert {ST}^{( f )} ( t ) - {ST}^{( o )} ( τ ) \vert}{max ( {ST}^{( f )} ( t ) , {ST}^{( o )} ( τ ) )} \qquad ( 3 )$$

where, RT^{(f)}(t) denotes a total amount of a forecasted meteorological element field at a time t; RT⁽⁰⁾(τ) denotes a total amount of an observed meteorological element field at a time τ; ST^{(f)}(t) denotes a total area covered by the forecasted meteorological element field at the time t; and ST⁽⁰⁾(τ) denotes a total area covered by the observed meteorological element field at the time τ;

S3: calculating a structural error of the meteorological element field;

firstly, calculating, based on a probability density function, a structural feature p^{(f)}(ζ^{f},t) of the forecasted meteorological element field and a structural feature p⁽⁰⁾(ζ⁰,τ) of the observed meteorological element field according to Eqs. (4) and (5), respectively;

$$\{ \begin{matrix}{p}^{( f )} ( {ξ}^{f} , t ) = {H}^{( f )} ( {ξ}^{f} , t ) \\ {ξ}^{f} = ( {R}^{f} - {R}_{min}^{f} ) / ( {R}_{max}^{f} - {R}_{min}^{f} ) ∈ [ 0 , 1 ]\end{matrix} \qquad ( 4 )$$

where, H^{(f)}(ζ^{f},t) denotes a probability density function for the forecasted target element field at the time t; ζ^{f} denotes a coefficient of the meteorological element after the forecasted meteorological element field is normalized; and ζ^{f} takes a value of 0-1;

$$\{ \begin{matrix}{p}^{( 0 )} ( {ξ}^{f} , t ) = {H}^{( 0 )} ( {ξ}^{0} , t ) \\ {ξ}^{0} = ( {R}^{0} - {R}_{min}^{0} ) / ( {R}_{max}^{0} - {R}_{min}^{0} ) ∈ [ 0 , 1 ]\end{matrix} \qquad ( 5 )$$

where, H⁽⁰⁾(ζ⁰,t) denotes a probability density function for the observed target element field at the time t; ζ⁰ denotes a coefficient of the meteorological element after the observed meteorological element field is normalized; and ζ takes a value of 0-1; and

secondly, measuring, based on a Kullback-Leibler (KL) divergence algorithm (6), a similarity E_{H} between the structural feature of the forecasted meteorological element field and the structural feature of the observed meteorological element field;

$${E}_{H} = {\sum }_{{ξ}^{f}} {p}^{( f )} ( {ξ}^{f} , t ) log \frac{{p}^{( f )} ( {ξ}^{f} , t )}{{p}^{( o )} ( {ξ}^{o} , t )} \qquad ( 6 )$$

S4: calculating a similarity between the target element field and the observed element field;

calculating the similarity E between the forecasted meteorological element field and the observed element field according to Eq. (2);

$$E = {E}_{R} + {E}_{S} + {E}_{H} \qquad ( 7 )$$

where, E_{R} denotes the total amount error of the meteorological element; E_{S} denotes the total area error of the meteorological element; and E_{H} denotes the structural error of the meteorological element.

Furthermore, in the present disclosure, the method considers a time error Eₜ between the forecasted meteorological element field \vec{α}^{(f)}(t) and the observed meteorological element field \vec{α}⁽⁰⁾(τ) at consecutive times, specifically as follows:

firstly, calculating, within a time range of t=τ±2Δt, the similarity E(t,τ) between the forecasted meteorological element field \vec{α}^{(f)}(t) at each time and the observed element field \vec{α}⁽⁰⁾(τ) at the time t according to steps S1 to S4; calculating the time error as τ−t, wherein when a similarity E (t,τ) reaches a maximum value, the time corresponding to the forecasted meteorological element field is t; and normalizing according to Eq. (8) to acquire a normalized time error Eₜ;

$${E}_{t} = \frac{\vert τ - t \vert}{2 Δ t} \qquad ( 8 )$$

where, Eₜ denotes the time error between the forecasted meteorological element field \vec{α}^{(f)}(t) and the observed meteorological element field \vec{α}⁽⁰⁾(τ) at the consecutive times; and Δt denotes a time interval of the forecasted meteorological element field; and

secondly, acquiring an overall error E between the forecasted meteorological element field and the observed meteorological element field, where E=E_{R}+E_{S}+E_{H}+Eₜ.

Further, the meteorological element includes rainfall, radar reflectivity, temperature, visibility, and wind speed.

Beneficial Effects. Compared with the prior art, the present disclosure has the following advantages.

(1) The present disclosure abstracts the problem of correcting the forecast error of the meteorological element into a graphical and mathematical model, which conforms to the intuitive perception of human on judgment errors and facilitates the solution of the problem through advanced mathematical and graphics methods.

(2) The prior art is essentially based on point-to-point verification and right or wrong verification and is subject to “double punishment”. In contrast, the present disclosure performs error analysis based on a normalized numerical value-area curve of the meteorological element, which can reasonably and objectively reflect the overall accuracy of meteorological element forecasting.

(3) The present disclosure homogenizes the errors in the coverage area of the element, the numerical value of the element, the distribution structure of the element, and the time, taking into account multiple factors of the forecast error of the meteorological element, and solving the problem that different types of errors cannot be added.

### BRIEF DESCRIPTION OF THE DRAWINGS

FIG. 1 shows a value-coverage area curve of a meteorological element according to the present disclosure;

FIGS. 2A and 2B show an example of a meteorological element field according to the present disclosure, where FIG. 2A is an example of forecasted meteorological element field \vec{α}^{(f)}(t) at time t; and FIG. 2B is an example of observed meteorological element field \vec{α}⁽⁰⁾(τ) at time τ; and

FIG. 3 shows original numerical value-area distribution curves and normalized distribution curves of the forecasted meteorological element field and the observed meteorological element field according to the present disclosure.

### DETAILED DESCRIPTION OF THE EMBODIMENTS

The following further describes the present disclosure with reference to the drawings and specific embodiments. It should be understood that these embodiments are only used to illustrate the present disclosure, not to limit the scope of the present disclosure. Those skilled in the art should understand that any equivalent modifications to the present disclosure shall fall within the scope defined by the claims.

The quantitative calculation of weather forecast error has always been a research topic, and its essence is to discuss the distribution similarity of the target element in the forecasted field and in the observed field. To discuss the distribution similarity of the target element, it is first necessary to define the distribution feature of the target element. The present disclosure proposes a method for quantifying a structural feature forecast error of a meteorological element based on a graphical similarity. The present disclosure provides an evaluation technique for the forecast error of the meteorological element based on the concept of graphical similarity. This technique aims to evaluate the forecast error of a scalar meteorological element. For concise expression, the scalar meteorological element that needs to be evaluated is referred to as the target element, and the evaluation process is detailed as follows.

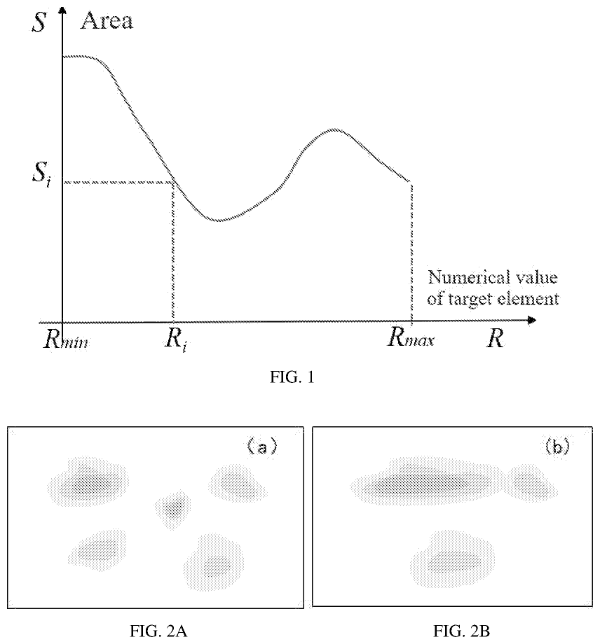

As shown in FIGS. 1 to 3, in the present disclosure, the method first defines an overall distribution feature of the target element (i.e. target meteorological element to be analyzed, such as rainfall, radar reflectivity, temperature, visibility, or wind speed) as total area S of the target element, total amount R of the target element, and structure H of the target element. Therefore, the overall feature of a target element field is expressed as structure \vec{α}:

$$\vec{α} = [ S , R , H ] \qquad ( 1 )$$

In the equation, the area S of the target element is defined as the area of a spatial range covered by the target element, and the total amount R of the total target element is defined as a total size of the target element within a target region. The structural feature H of the target element reflects the size and spatial distribution of the target element, and is expressed as a numerical size-area graph of the target element, meaning the area covered by the target element of a certain size. As shown in FIG. 1, Sᵢ denotes the area covered by the target element of size Rᵢ, and Rₘₐₓ denotes a maximum value of the target element.

In addition, in the present disclosure, the method further considers a time error of the forecasted field, which is defined as follows. In forecasted target element field {\vec{α}^{(f)}(t), t=t₁, t₂, . . . } at consecutive times and observed target element field {\vec{α}⁽⁰⁾(τ), τ=t₁, t₂, . . . } at the consecutive times (as shown in FIGS. 2A and 2B), observed target element field \vec{α}⁽⁰⁾(τ) with the greatest similarity to the forecasted target element field \vec{α}^{(f)}(t) at time t is found. Since the time of the forecasted field is t, the corresponding time of the observed field with the greatest similarity to the forecasted field is t, so the time error is τ−t. Starting from the actual situation, it is agreed that |τ−t|≤2Δt (i.e., the time range of t=τ±2Δt), where Δt denotes a time interval of the forecasted field, that is, the time error between the forecasted target element field and the observed target element field does not exceed 2 forecast time intervals. The time error is normalized as follows:

$${E}_{r} = \frac{\vert τ - t \vert}{2 Δ t} \qquad ( 2 )$$

It is necessary to calculate the similarity between the forecasted target element field \vec{α}^{(f)}(t) and the observed target element field \vec{α}⁽⁰⁾(τ). According to the meaning of components of feature quantity of the target element field, the similarity between the two target element fields refers to the similarity of the total area S, the total amount R, and the distribution pattern H of the target element. Therefore, by calculating the similarity of these three parameters step by step, a quantitative expression of the forecast error of structural feature of the meteorological element can be acquired as follows.

Step 1. The total amount error E_{R} of the target element is calculated

according to Eq. (3):

$${E}_{R} = \frac{\vert {RT}^{( f )} ( t ) - {RT}^{( o )} ( τ ) \vert}{max ( {RT}^{( f )} ( t ) , {RT}^{( o )} ( τ ) )} \qquad ( 3 )$$

The total area error E_{S} of the target element is calculated according to Eq. (4):

$${E}_{S} = \frac{\vert {ST}^{( f )} ( t ) - {ST}^{( o )} ( τ ) \vert}{max ( {ST}^{( f )} ( t ) , {RT}^{( o )} ( τ ) )} \qquad ( 4 )$$

where, RT^{(f)}(t) denotes a total amount of a forecasted target element field at time t (a cumulative numerical value of the target element at each point in the region); RT⁽⁰⁾(τ) denotes a total amount of the observed target element field at time τ; ST^{(f)}(t) denotes a total area covered by the forecasted target element field at the time t; and ST⁽⁰⁾(τ) denotes a total area covered by the observed target element field at the time t.

Step 2. Structural error E_{H} between the forecasted target element field \vec{α}^{(f)}(t) and the observed target element field α^{(t)}(τ) is calculated.

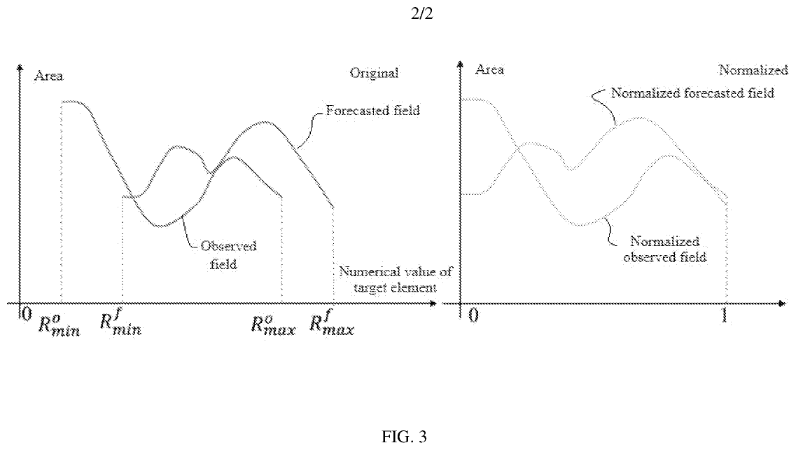

In FIG. 3, the left figure shows an original numerical value-area distribution of the observed field and the forecasted target element field, where Rₘᵢₙ⁰ denotes a minimum value of the target element in the observed field, Rₘₐₓ⁰ denotes a maximum value of the target element in the observed field, Rₘᵢₙ^{f} denotes a minimum value of the target element in the forecasted field, and Rₘₐₓ^{f} denotes a maximum value of the target element in the forecasted field. In FIG. 3, the right figure shows a normalized numerical value-area distribution of the observed target element field and the forecasted target element field.

In the present disclosure, the structural feature of the target element is expressed by a probability density function of the target element. The structural feature of the normalized forecasted target element field is expressed by Eq. (5), and the structural feature of the normalized observed target element field is expressed by Eq. (6):

$$\{ \begin{matrix}{p}^{( f )} ( {ξ}^{f} , t ) = {H}^{( f )} ( {ξ}^{f} , t ) \\ {ξ}^{f} = ( {R}^{f} - {R}_{min}^{f} ) / ( {R}_{max}^{f} - {R}_{min}^{f} ) ∈ [ 0 , 1 ]\end{matrix} \qquad ( 5 )$$

$$\{ \begin{matrix}{p}^{( 0 )} ( {ξ}^{f} , t ) = {H}^{( 0 )} ( {ξ}^{0} , t ) \\ {ξ}^{0} = ( {R}^{0} - {R}_{min}^{0} ) / ( {R}_{max}^{0} - {R}_{min}^{0} ) ∈ [ 0 , 1 ]\end{matrix} \qquad ( 6 )$$

where, H^{(f)}(ζ^{f}, t) denotes a probability density function for the forecasted target element field at the time t; ζ^{f} denotes a coefficient of the target element after the forecasted field is normalized; ζ^{f}=(R^{f}−Rₘᵢₙ^{f})/(Rₘₐₓ^{f}−Rₘᵢₙ^{f}); H⁽⁰⁾(ζ⁰, τ) denotes a probability density function for the observed target element field at the time τ; ζ⁰ denotes a coefficient of the numerical value of the target element after the observed field is normalized, ζ⁰=(R⁰−Rₘᵢₙ⁰)/(Rₘₐₓ⁰−Rₘᵢₙ⁰); and ζ^{f} and ζ⁰ take a value of 0-1.

Step 3. A similarity between the structural feature of the forecasted target element field and the structural feature of the observed target element field is measured based on a Kullback-Leibler (KL) divergence algorithm:

$${E}_{H} = K L ( {p}^{( f )} ( {ξ}^{f} , t ) \vert {p}^{( o )} ( {ξ}^{o} , τ ) ) = {Σ}_{{ξ}^{f}} {p}^{( f )} ( {ξ}^{f} , t ) log \frac{{p}^{( f )} ( {ξ}^{f} , t )}{{p}^{( o )} ( {ξ}^{o} , τ )} \qquad ( 7 )$$

where, KL(p^{(f)}(ζ^{f},t)|p⁽⁰⁾(ζ⁰,τ)) denotes a relative entropy of p^{(f)}(ζ^{f},t) and p⁽⁰⁾(ζ⁰,τ), which is calculated according to the right-hand side of Eq. (7).

Eqs. (3), (4), and (7) are used to calculate the similarity in the total amount, total area, and structure of the target element field. E_{R} [symbol] E_{S} [symbol] E_{H} take values of [0,1], which are logically comparable. Therefore, the overall similarity between the forecasted target element field \vec{α}^{(f)}(t) at the time and the observed target element field \vec{α}⁽⁰⁾(τ)at the time τ is defined as follows:

$$E = {E}_{R} + {E}_{S} + {E}_{H} \qquad ( 8 )$$

Under the framework of Eq. (2), when E(t, τ) is minimized, Eₜ is the time error between the forecasted target element field and the observed target element field, and the overall error is:

$$E = {E}_{R} + {E}_{S} + {E}_{H} + {E}_{t} \qquad ( 9 )$$

The above are merely preferred specific embodiments of the present disclosure, but the protection scope of the present disclosure is not limited thereto. Any equivalent replacement or modification made by a person skilled in the art according to the technical solutions of the present disclosure and inventive concepts thereof within the technical scope of the present disclosure shall fall within the protection scope of the present disclosure.

1. A method for quantifying a structural feature forecast error of a meteorological element based on a graphical similarity, comprising the following steps:
S1: defining a structural feature of a meteorological element field;
defining an overall structural feature d of the meteorological element field as an area S of a spatial range covered by the meteorological element, a total numerical size R of the meteorological element in a target region, and a structure H of the meteorological element;
$$\vec{α} = [ S , R , H ] \qquad ( 1 )$$
wherein, \vec{α} denotes the overall structural feature of the meteorological element field;
S2: calculating a total amount error and a total area error of the meteorological element;
$${E}_{R} = \frac{\vert {RT}^{( f )} ( t ) - {RT}^{( o )} ( τ ) \vert}{max ( {RT}^{( f )} ( t ) , {RT}^{( o )} ( τ ) )} \qquad ( 2 )$$
$${E}_{S} = \frac{\vert {ST}^{( f )} ( t ) - {ST}^{( o )} ( τ ) \vert}{max ( {ST}^{( f )} ( t ) , {RT}^{( o )} ( τ ) )} \qquad ( 3 )$$
wherein, RT^{(f)}(t) denotes a total amount of a forecasted meteorological element field at a time t; RT⁽⁰⁾(τ) denotes a total amount of an observed meteorological element field at a time τ; ST^{(f)}(t) denotes a total area covered by the forecasted meteorological element field at the time t; and ST⁽⁰⁾(τ) denotes a total area covered by the observed meteorological element field at the time τ;
S3: calculating a structural error of the meteorological element field;
firstly, calculating, based on a probability density function, a structural feature p^{(f)}(ζ^{f},t) of the forecasted meteorological element field and a structural feature p⁽⁰⁾(ζ⁰,τ) of the observed meteorological element field according to Eqs. (4) and (5), respectively;
$$\{ \begin{matrix}{p}^{( f )} ( {ξ}^{f} , t ) = {H}^{( f )} ( {ξ}^{f} , t ) \\ {ξ}^{f} = ( {R}^{f} - {R}_{min}^{f} ) / ( {R}_{max}^{f} - {R}_{min}^{f} ) ∈ [ 0 , 1 ]\end{matrix} \qquad ( 4 )$$
wherein, H^{(f)}(ζ^{f},t) denotes a probability density function for the forecasted target element field at the time t; ζ^{f} denotes a coefficient of the meteorological element after the forecasted meteorological element field is normalized; and ζ^{f} takes a value of 0-1;
$$\{ \begin{matrix}{p}^{( 0 )} ( {ξ}^{f} , t ) = {H}^{( 0 )} ( {ξ}^{0} , t ) \\ {ξ}^{0} = ( {R}^{0} - {R}_{min}^{0} ) / ( {R}_{max}^{0} - {R}_{min}^{0} ) ∈ [ 0 , 1 ]\end{matrix} \qquad ( 5 )$$
wherein, H⁽⁰⁾(ζ⁰,t) denotes a probability density function for the observed target element field at the time t; ζ⁰ denotes a coefficient of the meteorological element after the observed meteorological element field is normalized; and ζ⁰ takes a value of 0-1; and
secondly, measuring, based on a Kullback-Leibler (KL) divergence algorithm (6), a similarity E_{H} between the structural feature of the forecasted meteorological element field and the structural feature of the observed meteorological element field;
$${E}_{H} = {\sum }_{{ξ}^{f}} {p}^{( f )} ( {ξ}^{f} , t ) log \frac{{p}^{( f )} ( {ξ}^{f} , t )}{{p}^{( o )} ( {ξ}^{o} , t )} \qquad ( 6 )$$
S4: calculating a similarity between the target element field and the observed element field;
calculating the similarity E between the forecasted meteorological element field and the observed element field according to Eq. (2);
$$E = {E}_{R} + {E}_{S} + {E}_{H} \qquad ( 7 )$$
wherein, E_{R} denotes the total amount error of the meteorological element; E_{S} denotes the total area error of the meteorological element; and E_{H} denotes the structural error of the meteorological element.

2. The method for quantifying the structural feature forecast error of the meteorological element based on the graphical similarity according to claim 1, wherein the method further considers a time error Eₜ between the forecasted meteorological element field \vec{α}^{(f)}(t) and the observed meteorological element field \vec{α}⁽⁰⁾(τ) at consecutive times, specifically as follows:
firstly, calculating, within a time range of t=τ±2Δt, the similarity E(t,τ) between the forecasted meteorological element field \vec{α}^{(f)}(t) at each time and the observed element field \vec{α}⁽⁰⁾(τ) at the time τ according to steps S1 to S4; calculating the time error as τ−t, wherein when a similarity E(t,τ) reaches a maximum value, the time corresponding to the forecasted meteorological element field is t; and
normalizing according to Eq. (8) to acquire a normalized time error Eₜ;
$${E}_{t} = \frac{\vert τ - t \vert}{2 Δ t} \qquad ( 8 )$$
wherein, Eₜ denotes the time error between the forecasted meteorological element field \vec{α}^{(f)}(t) and the observed meteorological element field \vec{α}⁽⁰⁾(τ) at the consecutive times; and Δt denotes a time interval of the forecasted meteorological element field; and
secondly, acquiring an overall error E between the forecasted meteorological element field and the observed meteorological element field, wherein E=E_{R}+E_{S}+E_{H}+Eₜ.

3. The method for quantifying the structural feature forecast error of the meteorological element based on the graphical similarity according to claim 1, wherein the meteorological element comprises rainfall, radar reflectivity, temperature, visibility, and wind speed.
